(19) United States
(12) Patent Application Publication
(10) Pub. No.: US 2022/0082042 A1
(43) Pub. Date: Mar. 17, 2022

(54) APPARATUS AND METHOD FOR GASEOUS EMISSIONS TREATMENT WITH RESISTIVE HEATING

(71) Applicant: Advanced Technology Emission Solutions Inc., Toronto (CA)

(72) Inventors: Robin Crawford, Carlisle (CA); John Douglas, Brantford (CA)

(21) Appl. No.: 17/477,719

(22) Filed: Sep. 17, 2021

Related U.S. Application Data
(60) Provisional application No. 63/079,983, filed on Sep. 17, 2020.

(51) Int. Cl. F01N 3/20

(52) U.S. Cl. CPC F01N 3/2013; F01N 2240/16; F01N 2900/0412; F01N 2560/06; F01N 2450/22; F01N 2900/0602

(57) ABSTRACT

An assembly for treating gaseous emissions has a ceramic substrate body through which extend passages. The assembly has metal wires in selected ones of the passages, a first section of each wire electrically connected at one end thereof to an end of a second wire section and a distal end of the second section electrically connected to one end of a third wire section. The first and third wire sections are composed of a material having a lower electrical resistance than that of the second wire section. Part of each second wire section is located in a respective one of the selected passages.

### CROSS REFERENCE TO RELATED PATENTS

The present application claims priority pursuant to 35 U.S.C. 119(e) to pending U.S. Provisional Application Ser. No. 63/105,727 entitled “Apparatus and method for gaseous emissions treatment with resistive heating” filed Sep. 17, 2020, the disclosure of which application is incorporated herein by reference in its entirety and made part of the present application for all purposes.

### FIELD OF THE INVENTION

This invention relates to a structures and methods of operation of catalytic converters, particulate filters (PFs), selective catalytic reduction (SCR) units, and like structures for treating exhaust gases to reduce harmful pollution and has particular but not exclusive application to reducing pollution from internal combustion engines at start-up and when idling.

### BACKGROUND

Catalytic converters, PFs and SCR units are used in internal combustion engines to reduce noxious exhaust emissions arising when fuel is burned as part of the combustion cycle. Significant among such emissions are carbon monoxide and nitric oxide. These gases are dangerous to health but can be converted to less noxious gases by oxidation respectively to carbon dioxide and nitrogen/oxygen. Other noxious gaseous emission products, including unburned hydrocarbons, can also be converted either by oxidation or reduction to less noxious forms. The conversion processes can be effected or accelerated if they are performed at high temperature and in the presence of a suitable catalyst being matched to the particular noxious emission gas that is to be processed and converted to a benign gaseous form. For example, typical catalysts for the conversion of carbon monoxide to carbon dioxide are finely divided platinum and palladium, while a typical catalyst for the conversion of nitric oxide to nitrogen and oxygen is finely divided rhodium.

Catalytic converters, PFs and SCR units have low efficiency when cold, i.e. the running temperature from ambient air start-up temperature to a temperature of the order of 300° C. or “light-off” temperature, being the temperature where the metal catalyst starts to accelerate the pollutant conversion processes previously described. Light-off is often characterized as the temperature at which a 50% reduction in toxic emissions occurs and for gasoline is approximately 300° C. Below light-off temperature, little to no catalytic action takes place. This is therefore the period during a vehicle's daily use during which most of the vehicle's polluting emissions are produced. Getting the catalytic converter, PF or SCR unit hot as quickly as possible is important to reducing cold start emissions.

### BRIEF DESCRIPTION OF THE DRAWINGS

For simplicity and clarity of illustration, elements illustrated in the accompanying figure are not drawn to common scale. For example, the dimensions of some of the elements are exaggerated relative to other elements for clarity. Advantages, features and characteristics of the present invention, as well as methods, operation and functions of related elements of structure, and the combinations of parts and economies of manufacture, will become apparent upon consideration of the following description and claims with reference to the accompanying drawings, all of which form a part of the specification, wherein like reference numerals designate corresponding parts in the various figures, and wherein:

FIG. 1 is a longitudinal sectional view of a known gaseous emissions treatment unit.

FIG. 2 shows a ceramic substrate for an emissions treatment system according to an embodiment of the invention, the substrate having heating wire in one form of resistive heating configuration.

FIG. 3 shows a ceramic substrate for an emissions treatment system according to another embodiment of the invention, the substrate wired with another form of resistive heating configuration.

FIG. 4 shows a ceramic substrate for an emissions treatment system according to a further embodiment of the invention, the substrate wired with a further form of resistive heating configuration.

FIG. 5 shows a ceramic substrate for an emissions treatment system according to yet another embodiment of the invention, the substrate wired with yet another form of resistive heating configuration.

FIG. 6 shows a ceramic substrate for an emissions treatment system according to an embodiment of the invention, the substrate wired with a form of resistive heating configuration.

FIG. 7 shows a ceramic substrate for an emissions treatment system according to another embodiment of the invention, the substrate wired with another form of resistive heating configuration.

FIG. 8 shows a ceramic substrate for an emissions treatment system according to a further embodiment of the invention, the substrate wired with a further form of resistive heating configuration.

FIG. 9 shows a ceramic substrate for an emissions treatment system according to yet another embodiment of the invention, the substrate wired with yet another form of resistive heating configuration.

FIG. 10 shows a ceramic substrate for an emissions treatment system according to an embodiment of the invention, the substrate wired with a form of resistive heating configuration.

FIG. 11 shows an assembly for an emissions treatment system according to an embodiment of the invention, the assembly having a sub-assembly for resistive heating and a sub-assembly for inductive heating.

### DETAILED DESCRIPTION OF THE INVENTION INCLUDING THE PRESENTLY PREFERRED EMBODIMENTS

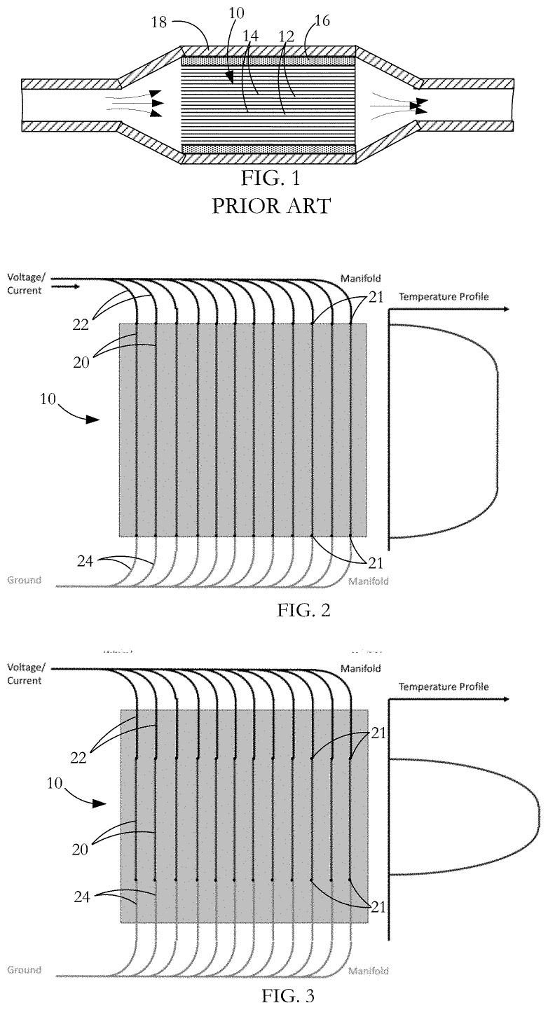

A gaseous emissions treatment assembly may take any of a number of forms. Typical of these is a known catalytic converter having a cylindrical substrate body 10 usually made of ceramic material and often called a brick, an example of which is shown in FIG. 1. The brick can have a honeycomb structure in which a number of small area passages or cells 12 extend the length of the brick, the cells being separated by walls 14. There are typically from 400 to 900 cells per square inch (cpsi) of cross-sectional area of the substrate body 10 and the walls are typically in the range 0.003 to 0.008 inches in thickness. Typically, the ceramic substrate body 10 is formed in an extrusion process in which green ceramic material is extruded through an appropriately shaped die and units are cut successively from the extrusion, the units being then cut into bricks. The areal shape of the cells or passages 12 may be whatever is convenient for contributing to the overall strength of the substrate body 10 while presenting a large contact area at which flowing exhaust gases can interact with a hot catalyst (not shown) coating the interior walls 14 of the cells 12. In other gaseous emissions treatment such as PFs, there may or may not be catalyst coating on the passage walls. In PFs, a checkerboard subset of cells have their front ends plugged, a ‘reverse’ checkerboard subset of cells have their back ends plugged, and gaseous emissions are treated by being driven though porous walls of the honeycomb structure from cells of the first subset into cells of the reverse subset.

In the catalytic converter, interiors of the tubular passages 12 are wash-coated with a layer containing a particular catalyst material. A wash-coat typically contains a base material, suitable for ensuring adherence to the cured ceramic material of the substrate body, and entrained particulate catalyst material for promoting specific pollution-reducing chemical reactions. Examples of such catalyst materials are platinum and palladium which are catalysts effective in converting carbon monoxide and oxygen to carbon dioxide, and rhodium which is a catalyst suitable for converting nitric oxide to nitrogen and oxygen. Other catalysts are known which promote high temperature oxidation or reduction of other gaseous materials. The wash-coating is prepared by generating a suspension of the finely divided catalyst in a ceramic paste or slurry, the ceramic slurry serving to cause the wash-coat layer to adhere to the walls of the ceramic substrate body. As an alternative to wash-coating to place catalyst materials on the substrate body surfaces, the substrate body material itself may contain a catalyst so that brick walls themselves present catalyst material at the internal surfaces bounding the cells.

Exhaust gases from diesel (compression combustion) engines contain more nitrogen oxides than gasoline (spark combustion) engines. Long-term exposure to nitrogen oxides even at low levels can cause temporary or permanent respiratory problems. In selective catalytic reduction (SCR) units, a liquid reductant is injected into a diesel engine exhaust flow to combine with nitrogen dioxide and nitric oxide (referred to collectively as NOₓ) in the exhaust gas. A preferred reductant is aqueous urea (2(NH₂)₂CO which is often referred to as diesel exhaust fluid (DEF). In the presence of a catalyst, ammonia resulting from thermal decomposition of the urea combines with the nitrogen oxides to produce less harmful products, chiefly nitrogen and water. Other reductants such as anhydrous ammonia and aqueous ammonia may also be used as an alternative to urea although especially for automotive application, on-board storage presents greater difficulty. Suitable catalysts may be any of certain metals oxides (such as those of molybdenum, vanadium, and tungsten), certain precious metals and zeolites. The typical temperature range for a SCR reaction is from 360° C. to 450° C. with a catalyst such as activated carbon being used to stimulate lower temperature reactions. As in gasoline (spark combustion engines), diesel (pressure combustion) engines may experience a period after a start-up where the exhaust temperature is too cool for effective SCR NOx reduction processes to take place. Other catalytic converters in which the present invention finds application for preheating or supplementary heating are lean NOX catalyst systems, lean NOX trap systems and non-SCR systems. The present invention is applicable also to each of these nitrogen oxide emissions treatment assemblies.

A gaseous emissions treatment assembly may have a series of the substrate bodies or bricks 10, each having a particular catalyst layer or emissions treatment mode depending on the noxious emission to be reduced or neutralized. Gaseous emissions treatment bricks may be made of materials other than fired ceramic, such as stainless steel. Also, they may have different forms of honeycombed cells or passages than those described above. For example, cells can be round, square, hexagonal, triangular or other convenient cross-sectional shape. In addition, if desired for optimizing strength and low thermal capacity or for other purposes, some of the extruded honeycomb walls can be formed so as to be thicker than other of the walls or formed so that there is some variety in the shape and size of cells. Junctions between adjacent interior walls of a cell can be sharp angled or can present curved profiles.

Typically, as shown in FIG. 1, the wash-coated ceramic honeycomb brick 10 is wrapped in a ceramic fibrous expansion blanket 16. A stamped metal casing or can 18 transitions between the parts of an exhaust pipe (not shown) fore and aft of the gaseous emissions treatment unit so as to encompass the blanket wrapped brick. The casing 18 is typically made up of two half shell parts which are welded together to contain the brick and to seal it in place. The expansion blanket 16 provides a buffer between the casing 18 and the brick 10 to accommodate their dissimilar thermal expansion coefficients. The metal of the sheet metal casing 18 expands much more than the ceramic material of the brick at a given temperature increase and, if the two materials were bonded together or in direct contact with each other, destructive stresses would be experienced at the interface of the two materials. The blanket 16 also dampens vibrations from the exhaust system that might otherwise damage the brittle ceramic of the substrate body 10.

Brick shape, profile and cell densities vary among different manufacturers. For example, some bricks are round and some are oval. Some assemblies have single stage bricks that are generally heavily wash-coated with the catalyst metals, while others may have two or three bricks with different wash-coatings on each brick. Some exhausts have 900, 600 and 400 cpsi cell densities used in the full exhaust assembly, while others use only 400 cpsi bricks throughout. A close-coupled converter may be mounted up close to the exhaust manifold with a view to reducing the period between start-up and light-off temperature. An underfloor converter can be located further from the engine where it takes relatively longer to heat up, but can be relatively larger and used to treat the majority of gases once the exhaust assembly is up to temperature. In another configuration, a unit for reducing the period to light-off temperature and a unit to deal with high gas flow after light-off are mounted together in a common casing.

At one or more locations in the assembly, sensors mounted in the exhaust gas flow including within or adjacent the substrate body provide feedback to the engine control system for emission checking and tuning purposes. Aside from start-up, control of fuel and air input has the object typically of maintaining a 14.6:1 air: fuel ratio for an optimal combination of power and cleanliness. A ratio higher than this produces a lean condition—not enough fuel. A lower ratio produces a rich condition—too much fuel. The start-up procedure on some vehicles runs rich for an initial few seconds to get heat into the engine and ultimately the catalytic converter. The structures and operating methods described below for indirectly heating the catalyst layers and the exhaust gases can be used with each of a close-coupled catalytic converter, an underfloor converter, and a combination of the two. Outputs from the temperature sensors are taken to a controller at which the monitored temperature or temperatures are used to control when induction heating is switched on and off. Using an appropriate algorithm implemented at the controller, the monitored temperatures may also be used to control specific effects of the applied heating processes to achieve a particular heating pattern.

In use, the encased brick (or bricks) is mounted in the vehicle exhaust line to receive exhaust gases from the engine and to pass them to the vehicle tail pipe. The passage of exhaust gases through the gaseous emissions treatment unit heats the ceramic brick 10 to promote catalyst activated processes where the flowing gases contact the catalyst layer. Especially when the vehicle engine is being run at optimal operating temperature and when there is substantial throughput of exhaust gases, such treatment units operate substantially to reduce the presence of noxious gaseous emissions entering the atmosphere. Such units have shortcomings however at start-up when the interior of the brick is at low temperature, during idling during city driving or when waiting for a coffee at a Tim Hortons drive-through, and between electric driving periods for hybrid vehicles.

In one aspect of the present invention, a gaseous emissions treatment assembly such as that shown in FIG. 1 is modified as shown in any of FIGS. 2 to 10 to enable resistive heating of the assembly. Located within selected cells 12 are resistive heating wires 20. In one embodiment, the resistive heating wires 20 are in a regular array with one occupied passage in every 16, 25 or 49 passages. For alternative heating profiles, a non-regular array is adopted. For a practical optimization of emissions gas treatment and resistive heating, a suitable range of ratios is from 1 in 10 to 1 in 50 occupied cells.

The resistive heating wires 20 are fixed in place by a friction fit at least partially achieved by closely matching wire exterior area dimensions to the cell area dimensions so that surface roughness of the wire surface and the cell walls 14 locks the resistive heating wires 20 in place. Wires can also be formed with a non-linear element such as a bow or crimp so that the bow or crimp is straightened somewhat as the wire is inserted into a cell and so is held by the cell walls as inherent resilience of the wire tends to return it to its original bow or crimped shape. This is caused at least a part by the resistive heating wire bearing against a part of the cell walls 14 and so enhancing the friction fit to retain the resistive heating wire in place. The overall friction fit can be such as to resist gravity, vibration, temperature cycling, and pressure on the wires as exhaust gases pass through the substrate body. Wires may alternatively, or in addition, be fixed into the cells by bonding outer surface parts of the wires to interior surfaces of respective cells. A suitable composite adhesive may be a blend of materials chosen to reduce temperature cycling stress effects in which there may be significant metal wire expansion/contraction, but vanishingly small expansion/contraction of the ceramic substrate. This differential could otherwise produce stresses at the adhesive interface between the two materials. By using such a composite adhesive, movement of a bonded wire relative to the surrounding cell walls may be reduced while maintaining high heat transfer.

In one embodiment, the resistive heating wires are identical to each other in terms of composition and cross-sectional size and they extend the full length of each occupied cell. One of more of the wires can alternatively extend only part way along a cell; either located near the front, near the back, or at an intermediate location along the length of the cell. One or more of the wires can alternatively have a different composition and/or resistivity from other wires. One or more of the wires can alternatively have a different cross-sectional area and therefore resistance per unit length than other wires.

FIGS. 2 to 10 show different configurations of resistive heating wire 20 within a multi-celled ceramic substrate. Also illustrated for each case is a heat profile for the particular configuration. In most cases, the heat profile assumes resistive heating wire of uniform cross-sectional area and composition.

FIG. 2 shows resistive heating wires extending the full length of the cells, there being one wire in each occupied channel. A corresponding heating profile is shown.

FIG. 3 shows the use of resistance heated wires that are shorter than the length of the occupied cell. There is one wire in each occupied channel. A corresponding heating profile is shown.

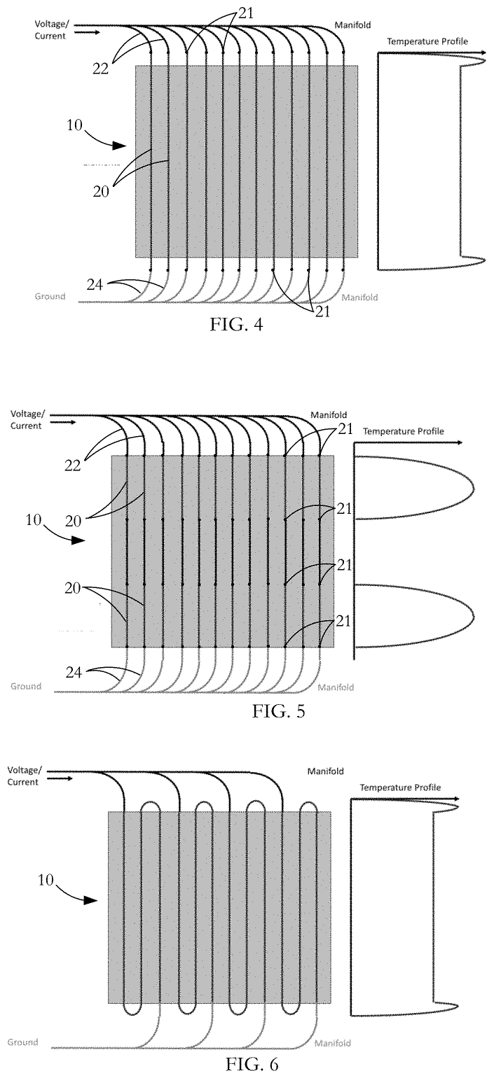

FIG. 4 shows the use of resistive heating wires that are longer than the length of the occupied cell, there being one wire in each occupied cell. A corresponding heating profile is shown.

FIG. 5 shows the use of resistance heated wire segments, each having a length less than the full cell length. Whereas there is one composite wire in each occupied channel, there are multiple resistance heated segments in each composite wire. A corresponding heating profile is shown.

FIGS. 2 to 5 show the use of a single wire or sections of wire in a cell. Through composition of material and/or gauge of wire, the wire must have a relatively high resistance per unit length to provide a desired heating effect.

FIG. 6 shows the use of resistive heating wire woven in such a way as to occupy two or more cells. A corresponding heating profile is shown.

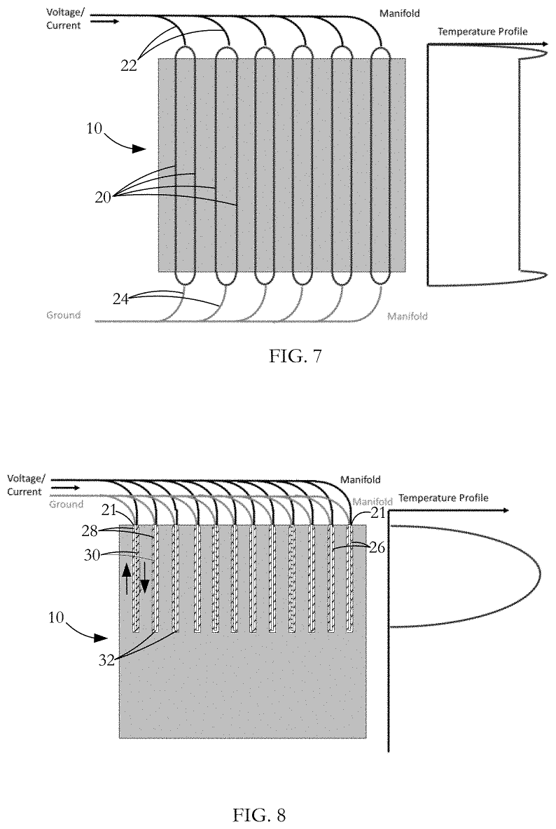

FIG. 7 shows the use of resistance heated wire loops extending through two or more cells. Each loop has one input lead 22 and one output lead 24 thus reducing the number of total connections to the main input and output manifolds. A corresponding heating profile is shown.

The looped and woven wire configurations shown in FIGS. 6 and 7 provide some retention of the resistive heating wire 20 resulting from the multiple passes through the cells 12. This retention may supplement or replace the bonding and resilience retention methods previously described.

FIG. 8 shows input and output leads 22, 24 connected to ends of a resistive heating wire that, as shown, has input and output heating sections 26, 28 separated by an insulating layer 30 to prevent shorting and forces input current to travel the full double path. Shorting would change the heat profile as the heat would not travel to the ends of the wire but instead would take the path of least resistance. The input and output sections are electrically connected at end zone 32. In one embodiment of this pigtail design, the resistive heating sections 26, 28 are of the same material composition, cross-sectional shape and area as each other. However, the sections can be of different material composition, resistivity/conductivity, cross-sectional shape and/or area from one another. A corresponding heating profile is shown for identical resistive heating sections.

FIGS. 6 to 8 show the use of a looped or woven resistance wire extending through multiple cells. Other things being equal, through composition of material and/or gauge of wire, the wires have a relatively lower resistance per unit length to provide the same heating effect compared with single wire embodiments.

In one manufacturing method for the FIG. 8 embodiment, two separate resistive heating wire lengths are positioned one on top of the other and then the tips are fused together at one end. In another manufacturing method, a double length of resistive heating wire is folded in half. In each case, an insulating layer is placed between the up and down resistive heating legs except at the end where they are fused or folded. In order that the wire can threaded into a substrate passage, the two resistive wire sections are shaped with a cross-sectional shape generally matching one half of the cross-sectional shape of the passage (less the thickness of the insulating layer). The design allows the connections for the voltage and ground to be on the same side of the ceramic substrate body and obviates having to pass the wire the full length of the ceramic (unless full length heating is desired).

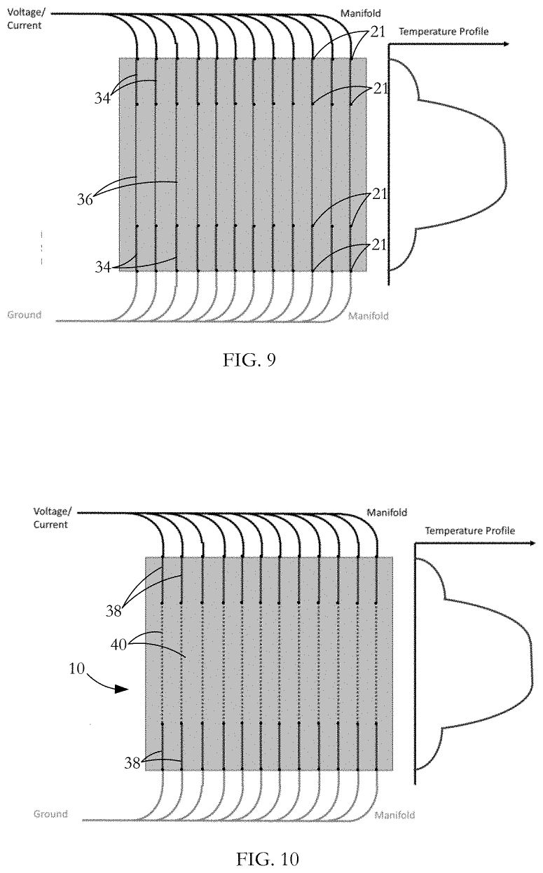

FIG. 9 shows the use of resistive heating wire sections 34, 36 having cross-sectional areas that change along the length of the wires. Reduction in area cross-section causes a comparative increase in resistive heating per unit length. This in turn causes a localized heating effect.

FIG. 10 shows the use of alloys of different composition and correspondingly different resistivity at different parts 38, 40 of the heating wire.

Heating is preferably controlled using a pulse width modulated (PWM) electrical power source in which heating control is determined by changing the frequency and pulse width of current pulsing. Control of heating is dependent on a number of factors. Applied heating current can be tuned to the resistive wire load to achieve high efficiency in terms of generating heat and speed to light-off. A heating pattern in the ceramic substrate is determined by appropriate location and configuration of the metal wires. Heating effects can be modified by appropriate adjustment of electrical power applied to individual resistive hearing wires. In particular, the applied current can be changed with time so that there is interdependence between the level of heating and the particular operational phase from pre-start-up to highway driving.

Of some importance is whether the resistive heating wire is in stationary air or is in a gas flow such as exhaust gas from vehicle engine operation or another induced flow. For example, in a pre-ignition phase, resistive heating wires are normally in stationary air while in a post-ignition phase, resistive heating wires are normally in a moving exhaust gas flow. If the heating wire is in stationary air, there is no gas flow to transfer heat away from the wire and so there is a heightened risk of the resistive heating wire overheating and burning out. Consequently, periods of applying heating current are reduced in the absence of airflow. Such a stepped current supply is for example adopted for a hybrid vehicle having an internal combustion engine operating during periods of driving time and an electric motor operating during intervening periods of driving time.

Whether from the viewpoint of performance or to prevent damage to the resistive heating wires, one or more temperature sensors can be positioned within or adjacent to the assembly. The temperature of a resistive heating wire may also be monitored so that specific and directed reduction in heating can be implemented if, for example, there is a localised risk of resistive heating wire damage or burnout.

In an alternative method of monitoring and controlling temperature, the rate of change of resistance with temperature for a heating wire is calibrated in prior testing. Such testing can be either or both of testing stock wire or testing specific catalytic converter units before their deployment. In operation of the catalytic converter, voltage applied to the heating elements is fixed and the current drawn by the heating elements is measured. From this measurement, the resistance of the heating elements is deduced and using a lookup table in the catalytic converter microcontroller, a temperature value is derived at any given time representing the average temperature of the heating elements inside the catalytic converter, PF or SCR unit (including any heating element parts located outside the ceramic substrate). The microcontroller uses PWM (pulse width modulation) to vary the current output to generate a desired temperature indicative of a steady state resistance). The temperature is that of the heating elements and region of the ceramic substrate in direct contact with the heating elements. However, the temperature may not be uniform throughout the ceramic substrate. Temperature variations will depend on the mass of the ceramic substrate and where the heating elements are placed in the substrate.

In one embodiment of the invention, the resistive wire section is very close in cross sectional area and/or shape to the cross-sectional area and shape of the cell within which it is accommodated. Substantially matching cross-sections so that the cell is almost fully blocked is advantageous in many respects. Close matching is generally the most efficient for heating which is predominantly conduction at touching points and radiation across any small gaps between the wire and the cell. The cross-sectional shape of the resistive heating wire sections and/or the passages can be any of round, square, hexagonal, triangular, octagonal or other convenient shape. Although matching cell and wire profiles are desirable, it is not essential that they match.

In a preferred embodiment, wires are inserted or threaded into selected passages before the unit is wash coated with catalyst-containing wash coat slurry. The wash coat is deposited as a layer on the open cells and, in the same operation, fills, at least to some extent, gaps between the walls of the resistive heating wires and the walls of the passages in which they are accommodated. The wash coat in the occupied cells locks in the inserted or threaded resistive heating wires and can supplement or replace the previously described bonding and resilient element structures for retaining resistive wires in place. In use, with the resistive heaters either directly contacting the passage walls or joined by wash coat and/or bonding material, just about all heat transfer within the heater-filled passages is by conduction. In the wire loop embodiments of FIGS. 4, 6 and 7, the resistively heated wire sections are exposed beyond the faces of the ceramic substrate resulting, in operation, in direct heating of flowing emissions gas by radiation and convection.

The resistive heating wires or pins require wiring connections to a current source, this being indicated in the illustrated figures by the term ‘manifold’. Connections between supply wiring and resistively heated wires can be by any of resistance welded, laser welded, diffusion welded, brazed or the like.

Leads to and from the resistive elements are made of high conductivity metals or alloys capable of surviving the exhaust gas temperatures that are generated at the vehicle catalytic converter, PF or SCR unit. Examples of such metals are copper, aluminum and Inconel™ alloys.

For the resistive heating wire sections, nichrome, a nickel chromium alloy which may be alloyed with amounts of other materials such as iron, is particularly valuable.

Stainless steel falls somewhere in between high and low resistivity metals. With suitable alloying metals and appropriate wire cross-sectional area, stainless steel can function as a resistive heating wire section element. With other alloying metals and different wire cross-sectional area, it can function as the wire conductor sections. Inconel™ can also be suitably alloyed and gauged to function as either a high resistivity heating section or a low resistivity lead section. In one particular example, copper comprises the inlet and outlet manifold metals and nichrome constitutes the resistance heated sections.

As shown in several of FIGS. 2 to 10, a multi-section wire has a conducting section at each end of a central resistive heating wire section. For simplicity, the two conducting leads are made from the same conducting material although dissimilar conducting materials can alternatively be used. To facilitate manufacture, in one embodiment, the conducting leads are made smaller in cross-section than the resistive heating section with their resistivity being from 90% to 99% less than that of the resistive heating section material. Reducing the cross-section of the conducting wire by 10% compared with the resistive heating section aids wire insertion with minimal effect on heating performance. The first conducting lead is inserted first and acts as a guide as the cross-sectional area increases at the junction with the resistive section. The smaller cross-section conducting lead provides more tolerance for insertion robotics providing a high probability that cell openings are found quickly and accurately and that wires are inserted quickly into the cells. Placing the resistive wire directly into a cell is also possible but there are trade-offs in terms of insertion speed and accuracy.

Manufacturing using completed three- or multi-part wire assemblies is achieved by reel feeding both the conductor lead and resistive wire into a cutting and welding station. The feeder measures out the required length of the particular wire, cuts it to length and then this is held in the welding fixture. Then, the next wire of the other material is fed out, cut to length and then held in the welding fixture adjacent to the first wire. Joint are preferably either butt joints or overlap joints. Resistive or laser welding are preferred methods for fusing dissimilar materials together because no additional bonding material is needed at the weld site. The methods also produce a defined compositional transition between the two materials and thus a defined heating transition between them as well. A weld fixture is used to maintain the placement of wires when welding a resistive section to conducting section joint. For a three-section wire, a second joint is effected in the same manner and either the completed wire is ejected before a next wire is formed or a composite wire is continuously formed, collected on a reel and stored until later when it is cut to length.

The pigtail embodiment of FIG. 8 is manufactured in a similar manner. The same three wire sections (conductor lead, resistive section, conductor lead) exist with the only difference being the addition of an insulating layer. For a given ceramic cell size, the cross-sections of any length of the three part wire that is enclosed in a cell are reduced by 50% as the inlet and outlet leads, once inserted, bear against opposed sides of a cell wall and so only half the cell area can be used for each up and down leg if the wire is to fit in the cell. If the pigtail protrudes to a depth L into the ceramic substrate, then the resistive section is made to a length 2L. Insulating non-dielectric material such as tape, fibre, enamel, etc., is applied to one-half of the resistive section from 0 to L of the 2L length. At the midpoint of the 2L length, the wire is folded back on itself to trap the insulating layer between the two L length sections. The insulating layer forces the current to flow the full 2L length to achieve the desired heating profile and avoids electrical shorts that could adversely change the heating profile. Once prepared in this way, the pigtail is inserted into the cell. In another process for making the pigtail form, two wire parts each consisting of one conducting lead and one resistive section are placed one on top of the other and then the tips of the resistive sections are welded together. The resistive sections are each of length L so that when their tips are welded, the resistive section is of length 2L. The insulating layer is of length L minus the diameter (cross-section) of the resistive wire. This allows the tips to be properly welded whereupon the pigtail is inserted. Allowing the insulation to protrude into the tip area is avoided as it might otherwise result in an improper weld which, in turn, could produce in use either a hot spot or no current flow at all. In the pigtail design, both conducting input and output leads enter and exit the same face of the ceramic substrate. This means that there are twice as many leads at one end than with the through devices of FIGS. 2 to 7, 9 and 10.

In the embodiment of FIG. 8, it is important that none of the bare inlet leads short to any of the bare outlet leads as this prevents the resistive heating sections from heating up. This in turn changes the heating pattern and possibly damages the wire. To obviate this, in one embodiment, input leads start from a height above the substrate end which is different from the height above the substrate end from which the output leads terminate. In another separation technique, the leads are bent slightly away from each other as they exit the face of the ceramic.

Leads to the resistive heating elements may have parts located within the casing 18 and parts located outside the casing. In one embodiment, the leads are separate from each other within the casing and are combined outside the casing. Respective insulated through-wall connectors mechanically consolidate the input leads and the output leads into a main input cable at or near one end of the casing and a main output cable at or near the other end of the casing. The ceramic substrate is separated from the inner wall of the casing by a layer of insulation acting to provide both heat and electrical insulation.

The electrical leads and the resistive heating elements are made of materials that develop oxidation resistance when exposed to air and to hot emissions gas. Consequently, they resist environmental degradation without the need for directly contacting insulation. The leads are installed with minimal possible slack and even some slight tension to limit vibration during use. Vibration could otherwise jeopardize lead integrity in the long term or may result in undesirable metal contact with other elements of the assembly. When operating in a catalytic converter, PF or SCR unit, the leads, by virtue of their low area cross-section and the occupation density of the cells, do not add substantially to back pressure which might otherwise adversely affect vehicle engine performance.

Wiring the heating element, whether individual, looped or woven, is complex as there are both inlet and outlet connections to each of the resistance heating wires. With several hundred resistive heating wires for one ceramic substrate requires a large number of conducting leads.

Heating from a wire section predominantly exposed to air or flowing gaseous emissions mainly derives from radiation and convection. Heating from a wire section retained closely within a cell of the ceramic substrate is mainly conductive. At a transition between two wire sections, there is some combination of all three heat transfer mechanisms.

One example, for a 4 kW 48 V catalytic converter application with a 500° C. light-off temperature, used a 400 cpsi ceramic substrate 4 inches in diameter and 4 inches long. Wire gauge was 19 or 0.0359 inch diameter to substantially fill the cross-sectional area of the cells. A nichrome C resistive heating element was used having a composition of 60% nickel, 16% chromium and 24% iron so giving a service temperature up to 1000° C. This example had a 1:15 array pattern of occupied: unoccupied cells. 10 resistive wire heating elements were woven back and forth 17 times (34 channels blocked per wire). The 10 woven wires were connected in parallel to meet required power and voltage ratings.

In another example, a 400 cpsi ceramic substrate with 0.0045-inch wall thickness had 0.0455-inch effective diameter cells accommodating respectively 0.0359-inch effective diameter wires. This left a gap between the wire surface adjacent wall about 0.005 inches which enabled relatively easy wire insertion or weaving at the time of manufacture. A smaller gap is possible if manufacturing processes result in wire and cell walls that are particularly accurately shaped and dimensioned. Lowering the gap size with a view to better heat transfer during use is a compromise with maintaining ease of wire insertion into a cell. Ceramic glue/mastic or catalyst metal wash coat slurry was used to fill at least part of the gap and so increase heat transfer during use. In one example, the resistive heating wire was heated to a 500° C. maximum in order to heat the surroundings.

Other variations and modifications will be apparent to those skilled in the art and the embodiments of the invention described and illustrated are not intended to be limiting. The principles of the invention contemplate many alternatives having advantages and properties evident in the exemplary embodiments.

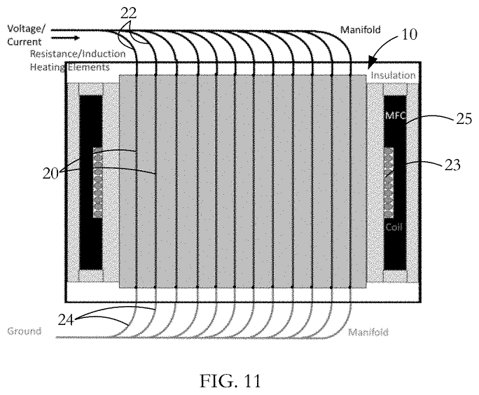

Referring to FIG. 11, in another such alternative, a resistive heating structure and method such as any of those previously described is combined with an inductive heating structure and method such as any of those described in the following U.S. patents which are assigned to applicant and which are hereby incorporated herein by specific reference: U.S. Pat. Nos. 9,488,085, 10,352,214, 10,975,747, 9,617,888, 10,280,821, 10,450,915, 10,143,967, 10,267,193, 10,626,766, 11,060,433, 10,364,720, 10,226,738, 10,941,686, 10,207,222, 10,132,221, 10,590,818, 10,662,845, 10,760,462, 10,557,392, 10,590,819, 10,918,994 and 10,835,864. While each of resistive heating and inductive heating is versatile on its own, combining into a single aftertreatment system can enhance this versatility and performance.

In a resistive heating system or an inductive heating system, if high power heating is required, this may result in greater size and/or cost of electrical components due to the high current draw. Splitting the power/current between two heating techniques—one resistive and the other inductive—can reduce the size and cost of such components. While more electrical components may be required overall, the size of these components is reduced such that system packaging is smaller compared with a single high power heating system. Electrical components can scale exponentially in size and cost with power/current requirements.

In a further alternative combination system, for fixed packaging requirements, the combination of resistive and inductive heating is structured and operated to boost the attainable power level beyond what is reasonably attainable for a single resistive or inductive system. Thus, for a specific design of resistive or inductive heating system, there is a highest efficiency operating regime for converting input energy to usable heat. Operating at non-optimal power levels reduces the efficiency of a particular heating system, whether for a resistive or inductive system. The efficiency level typically might range from a minimum of 50% up to maximum of 90% efficiency. Taking a total power requirement and splitting it between two heating systems allows overall efficiency to improve. Here, operating parameters are set so that neither the resistive nor inductive system is allowed to drop below a middle efficiency (say, 70%) level, with each heating technology taking a portion of the total power requirement. Starting at a low power level, the single-system would have the lowest efficiency, but the two-system approach would have a middle efficiency. As the power level is increased, the efficiency improves in both the single- and two-system approaches until the first heating system in the two-system approach is maxed out. This would also be a first system maximum efficiency while the single-system is at mid-efficiency. Increasing power further increases the efficiency of the single-system whereas the two-system approach would see a slight drop from the first maximum efficiency as the second heating technology is now working with the first. When both the heating technologies work together in the two-system approach, they can both run below their max powers at efficiencies slightly lower than the maximum, or one can run at maximum power and efficiency and other heating technology runs at its middle efficiency, with any combination between the two or an inverse of the example presented. At a maximum power requirement, the single-system and two-system arrangements are each heating at their maximum efficiency. The advantage of the two-system heating approach is that the total efficiency is always well above the minimum of the single-system.

In such a combination system, a ‘contained’ wire or other metal may be both a resistive heater and an inductive heater, a suitable exemplary material being Kanthal™. Such an insert can be used for resistive heating and inductive heating at the same or different times. If heated inductively and resistively at the same time, inductive heating has current more concentrated in a skin region of the metal while in resistive heating, current is relatively evenly spread throughout the cross-section of the metal content. In a variation, some metal inserts are dedicated to, and specifically adapted for, resistive heating, while other metal inserts are dedicated to, and specifically adapted for, inductive heating.

The above-mentioned US patents introduce various modifications and variations of a basic inductive heating system for aftertreatment of gaseous emissions such as those described in U.S. Pat. No. 10,352,214. Many of the structures and methods described in such patents can be adapted to resistive heating as now contemplated, whether or not combined with inductive heating. Such structures and methods include, for example, substitution of the metal wires 20 by a hollow wire, metal powder, molten metal, and deposited metal film. Such patents describe also exemplary methods for insertion and retention of these materials in such passages. It will be understood by those of ordinary skill in the art that structures and methods described in such patents can be adopted and applied, with or without some adaptation, in building and operating a resistive or resistive/inductive heating system as described above.

While the embodiments described above describe the use of metal wires within selected cells of a ceramic substrate, metal within the selected cells can be other than a wire, and include such forms as metal powder, molten metal, metal in matrix, metal deposited in a selected cell and metal in the material of the ceramic structure. The use of the word ‘wire’ throughout the specification and when applied to the wire interior of a selected cell is intended to cover such alternative embodiments of metal having desired resistivity characteristics. The use of the word ‘insert’ in the specification connotes more than just placement and is intended to cover pouring, flowing, deposition and like processes for introducing metal into a selected call.

In a combined resistive/inductive heating system ‘contained’ metal temperature affects the form of heating differently. Resistance heating efficiency improves with rising temperature because the resistance to current flow generally increases as temperature increases. Induction heating efficiency increases with temperature up to the Curie point, but the efficiency then drops off rapidly as magnetic properties that support induction heating are lost. While temperature control versus efficiency is challenging to balance, this can be mitigated by limiting the temperature and operating at the most efficient balance of the two heating systems. Alternatively, in a more general operating practice, induction is used at lower temperatures and resistance heating is used at higher temperatures.

To effectively combine the different heating schemes, real estate and other structural compromises may be necessary. Firstly, 3 or 4 electrical connections are necessary compared to only 1 or 2 for a single heating system. Secondly, resistance heating requires a positive voltage and a ground for current flow. For vehicular systems, ground may be to the exhaust system and thus to the chassis. Grounding to the exhaust system can be effected as a connection to the sheet metal inside the aftertreatment system. Induction heating requires 2 leads for the AC signal to and from the coil. Two controllers/power supplies are necessary because resistance heating requires a DC supply and the induction requires an AC supply. However, as noted previously, the physical size of the two-system design need not be more than that of a single—induction or resistive—heating system on its own.

What is claimed is:

1. An assembly for treating gaseous emissions comprising a ceramic substrate body having a plurality of passages, and a plurality of metal wires, a first section of each wire electrically connected at one end thereof to one end of a second section of the wire, a distal end of the second section electrically connected to one end of a third section of the wire, the first and third wire sections composed of a material having a lower electrical resistance than the second wire section, at least a part of the second wire sections located in a respective one of each of the passages of a subset of the plurality of passages.

2. The assembly as claimed in claim 1, further comprising first welds joining respective first and second wire sections to each other and second welds joining respective second and third wire sections to each other.

3. The assembly as claimed in claim 2, wherein the ends of the wire sections at the welds are butt joined.

4. The assembly as claimed in claim 2, wherein end portions of the wire sections at the welds overlap at respective welds.

5. The assembly as claimed in claim 1, wherein the second wire sections extend throughout the length of respective ones of the passages of the subset thereof.

6. The assembly as claimed in claim 1, wherein each of the second wire sections extends out of the respective passages of said subset thereof and beyond an end of the ceramic substrate body.

7. The assembly as claimed in claim 1, wherein each of the second wire sections has at least one end spaced inwardly from an end of the ceramic substrate body.

8. The assembly as claimed in claim 1, wherein at least a part of each of the first and third wire sections are located outside the passages.

9. The assembly as claimed in claim 1, wherein a plurality of the second wire sections is located within the length of a respective one of the passages of the subset, the third wire section contiguous with a first one of said plurality of second wire sections electrically connected to the first wire section of a second one of said plurality of second wire sections.

10. The assembly as claimed in claim 1, wherein at least one of the wires extends in a first direction along a first one of the passages of the subset thereof, loops at an end of the ceramic substrate body and extends in a second direction opposite to the first direction along a second one of the passages of the subset thereof.

11. The assembly as claimed in claim 1, wherein, at least one of the second wire sections has a fold, a first part of the second wire section folded back along the length of a second part of the second wire section at the fold, an insulating layer between the folded parts except at the position of the fold, the folded parts at least partly within one of the cells.

12. The assembly as claimed in claim 11, wherein the first and third wire sections electrically connected to the second section are located at a first end of the ceramic substrate body.

13. The assembly as claimed in claim 1 wherein at least one of the second wire sections has a cross-sectional area that changes along the length of the second wire section.

14. The assembly as claimed in claim 1 wherein at least one of the second wire sections has a composition that changes along the length of the second wire section.

15. The assembly as claimed in claim 1, further comprising a temperature sensor mounted at the substrate body and connected into a circuit for providing feedback to a control system for controlling an engine operable to generate the gaseous emissions to be treated.

16. The assembly claimed in claim 1, further comprising a controller module operable to measure voltage applied to one of the wires, to measure resulting current drawn by said one wire, to compute electrical resistance of said one wire and, using a previously populated lookup table, to derive an operating temperature of a part of the assembly.

17. The assembly claimed in claim 1, further comprising a second plurality of wires and an induction heating coil mounted adjacent the ceramic substrate body for generating a varying electromagnetic field, to thereby inductively heat the wires of the second plurality.

18. The assembly claimed in claim 17, wherein at least some of the wires of the second plurality thereof are respective third sections of the wires of the first plurality thereof.

19. A method of treating gaseous emissions comprising passing the gaseous emissions through a first subset of a plurality of passages in a ceramic substrate body, and passing current through wires, each wire having a first section thereof electrically connected at one end thereof to one end of a second section of the wire, a distal end of the second section electrically connected to one end of a third section of the wire, the second wire sections having a higher resistance than the first and third wire sections to which said second wire sections are electrically connected, the second wire sections at least partly located in passages of a second subset of the plurality of passages whereby passage of said current therethrough resistively heats the second wire sections and thereby heats the ceramic substrate body.

20. The method of claim 19, further comprising passing current through wires of a second plurality of wires and energizing an induction heating coil mounted adjacent the ceramic substrate body to generate a varying electromagnetic field, to thereby inductively heat the wires of the second plurality.
